(19) United States
(12) Patent Application Publication
(10) Pub. No.: US 2004/0214121 A1
(43) Pub. Date: Oct. 28, 2004

(54) Apparatus for and method of installing a mantle clip and mantle on a lantern

(75) Inventors: Norris Richard Long, Wichita, KS (US); Bill Nabors, Wichita, KS (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: The Coleman Company, Inc., Wichita, KS

(21) Appl. No.: 10/422,542

(22) Filed: Apr. 23, 2003

(51) Int. Cl. F23D 11/36; F21H 1/00

(52) U.S. Cl. 431/100; 431/154

(57) ABSTRACT

A mantle assembly including a holder, a mantle clip, and a mantle. The holder includes first and second abutment portions for biasing or otherwise holding end portions of the mantle clip so that an opening of the mantle clip is held in an open position. The end portions are held such that once the open portion of the mantle clip is placed onto a mantle base, the holder may be pulled away or otherwise manipulated so that the end portions slide out of or off of the abutment portions and the mantle clip may attach to the mantle base. The attachment of the mantle clip to the mantle base may be formed, for example, by the end portions biasing back into position after being released by the mantle holder, so that the middle portion becomes smaller and locks around the mantle base.

### TECHNICAL FIELD OF THE INVENTION

The present invention relates to lanterns, and more particularly, to a mantle assembly for a lantern.

### BACKGROUND OF THE INVENTION

Lanterns that burn liquid fuel or LP fuel are well known. Such lanterns include a burner assembly to which the fuel is delivered and one or more catalytic mantles which are mounted on the burner assembly. The fuel burns within the catalytic mantles and the mantles incandesce and provide a bright light. The mantles are usually surrounded by a glass cylindrical globe.

Mantles are generally formed from mesh material, and are shaped like a small bag with one open end. The open end is secured around the outlet end of a burner tube of the burner assembly of a lantern. The mantle may be attached, for example, by a drawstring. The drawstrings are difficult to attach, especially for individuals with decreased dexterity, such as individuals with arthritis.

To aid individuals in installing mantles, manufacturers have developed mantles that have metal spring clips at their upper ends. An example of such a mantle is disclosed in U.S. Pat. No. 5,639,231 (“the 231 patent”), commonly owned with the present invention by The Coleman Company, Inc. The '231 patent discloses a mantle assembly having a mantle mounted on a spring clip. The spring clip includes a generally circular portion which surrounds the mantle opening and a pair of end portions. The end portions are movable between first and second positions for changing the size of the opening of the central portion. A user squeezes the two end portions together so as to widen the spring clip opening to fit the spring clip onto a mantle mount.

Although the spring clips disclosed in the '231 patent work well for their intended purpose, it has been found that even with the use of these spring clips, some amount of dexterity is needed to squeeze the ends of the spring clips together. The ends are small and hard to handle and, even if a user is capable of squeezing the two ends together, it may be hard to align the separated clip onto a mantle mount, especially for a user having decreased dexterity.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a mantle assembly having a holder, a mantle clip, and a mantle. The holder includes first and second abutment portions for biasing or otherwise holding end portions of the mantle clip so that the opening of the mantle clip is held in an open position. The end portions are held such that once the open portion of the mantle clip is placed onto a mantle base, the holder may be pulled away or otherwise manipulated so that the end portions slide out of or off of the abutment portions and the mantle clip may attach to the mantle base. The attachment of the mantle clip to the mantle base may be formed, for example, by the end portions biasing back into position after being released by the mantle holder, so that the middle portion becomes smaller and locks around the mantle base.

In accordance with one aspect of the present invention, the mantle clip includes a generally circular central portion which is configured to surround a mantle opening and to fit onto a mantle base. End portions of the mantle clip are moveable between a first, opened position, in which the opening of the central portion may fit over the mantle base, and a second, closed position, in which the opening is made slightly smaller than or about the same size as a mantle base so that the mantle clip may be clamped thereon. The holder may be configured so as to hold the end portions in the first position, and release of the mantle clip from the holder causes the end portions to move to the second, closed position.

In accordance with another aspect of the present invention, the end portions cross, and the tips of the end portions are biased inwardly by the holder. Placing the mantle clip onto a mantle base and pulling the holder away causes the end portions to slide off the abutment portions, and to move away from one another so that the middle portion shrinks and may close around the mantle base.

In accordance with another aspect of the present invention, the holder may position the two end portions away from one another so that releasing the end portions causes the end portions to move toward one another and closes the central portion. The two end portions may be, for example, positioned in slots on the outside of the holder. The inside of the slots may define the first and second abutment portions. Putting the mantle clip onto a mantle base and pulling the holder away causes the two end portions to slide out of the slots and off of the two abutment portions and releases the two end portions so that they may move toward each other so that the central portion may close over the mantle base.

Other advantages will become apparent from the following detailed description when taken in conjunction with the drawings, in which:

### BRIEF DESCRIPTION OF THE DRAWINGS

FIG. 1 is a perspective view of a mantle holder being used to install a mantle and mantle clip on a lantern in accordance with one aspect of the present invention;

FIG. 2 is a side perspective view of a first mantle holder, mantle clip, and mantle assembly in accordance with the present invention;

FIG. 3 is an exploded view showing assembly of the holder and mantle clip of FIG. 2;

FIG. 4 is a side perspective view of a second mantle holder and mantle clip, with a mantle removed so that details may be seen;

FIG. 5 is an exploded view showing assembly of the holder and mantle clip of FIG. 4;

FIG. 6 is a side perspective view of the third mantle holder and mantle clip, with a mantle removed so that details may be seen; and

FIG. 7 is an exploded view showing assembly of the holder and mantle clip of FIG. 6.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention. In addition, to the extent that orientations of the invention are described, such as “top,” “bottom,” “front,” “rear,” and the like, the orientations are to aid the reader in understanding the invention, and are not meant to be limiting.

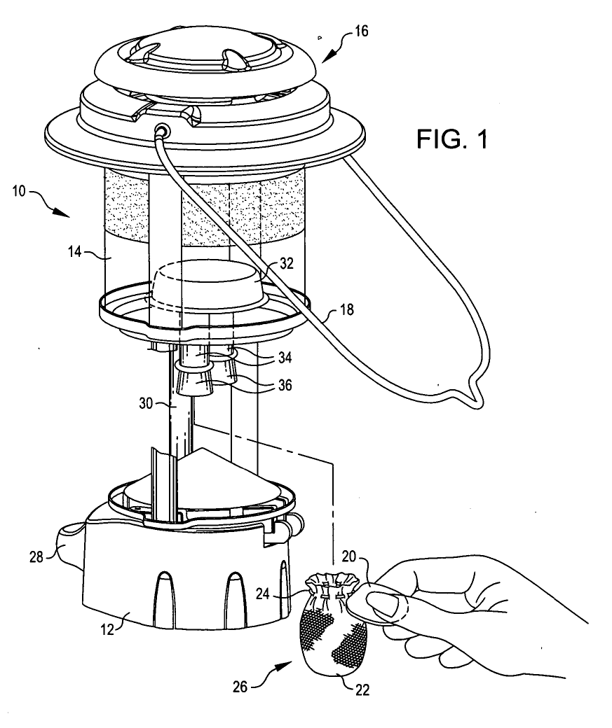

Referring now to the drawings, in which like reference numerals represent like parts throughout the several views, FIG. 1 shows a lantern 10, which is one example of a lantern onto which a holder 20 may be used to mount a mantle 22 and mantle clip 24 in accordance with the present invention. As used herein, the holder 20, the mantle 22, and the mantle clip 24 are referred to as a “mantle assembly, shown generally by the reference numeral 26 in FIG. 1.

The lantern 10 shown in the drawings includes a cylindrical collar 12 designed to fit onto an LP tank, such as a 16.4 ounce COLEMAN brand LP tank cylinder (not shown, but known in the art). A globe 14 mounts above the cylindrical collar 12, and a ventilator cap assembly 16 fits over the globe 14. A bail 18 is attached to the ventilator cap assembly 16.

In the embodiment shown, the globe 14 and the ventilator cap assembly 16 are designed to slide relative to the cylindrical collar 12. The lantern 10 shown in FIG. 1 is given as one example of a lantern in which the holder 20, mantle 22, and mantle clip 24 may be used. However, the holder 20, mantle 22, and mantle clip 24 may be used with any style of lantern that uses mantles. Although the details of the lantern 10 are not critical to practice of the invention, a user may find a description and function of that lantern in copending patent application docket number 306197, entitled “Sliding Globe Assembly for Lantern” and filed Apr. 18, 2003. In summary, the globe 14 and the ventilator cap assembly 16 slide upward relative to the cylindrical collar 12 so that mantles may be easily replaced, lighted, or installed in the lantern 10.

In general, lanterns (e.g., the lantern 10) include a burner assembly for mixing air and fuel and providing the mixed air and fuel mixture to the mantles. The components for a burner assembly of a lantern are known, but the burner assembly of the lantern 10 is generally described in this disclosure for the benefit of the reader. The lantern 10 includes a regulator (not shown, but known in the art) for dropping the pressure of the fuel from the propane tank 12 to a usable pressure for the lantern. The regulator is typically connected to a valve (also not shown) that is connected to a control knob 28, which is mounted on the cylindrical collar 18 in the embodiment shown in the drawings. Rotation of this control knob 28 increases or decreases the flow of fuel to the burner assembly.

In the burner assembly shown in the drawings, an air/fuel intake tube 30 extends upward from the cylindrical collar 18 to a manifold 32, very often called a “peanut” in the field of lanterns. A pair of burner tubes 34 extend downward from the manifold 32 to mantle mounts 36.

An igniter (not shown) may be provided for lighting the lantern 10. The use of such igniters is known, and the detail of a system is not provided herein. Alternatively, the lantern 10 may be lit manually, such as by a match.

In operation, a user rotates the control knob 28, causing the igniter to spark, and gas to be supplied through the air/fuel intake tube 30, the manifold 32 and out of the burner tubes 34 at the mantle mounts 36. The mantles 22, which are typically made of a catalytic material, such as yttrium, light and remain lit as long as fuel is supplied to the mantles 22.

In the embodiment shown, the burner tubes 34 extend downward. However, the aspects of the present invention may be utilized in a lantern which has a burner tube that extend upward, sideways, or at any angle. However, as is known in the art, the structure of the burner assembly shown in FIG. 3 is advantageous in that the mantles 22, once lit, provide pre-heating of the fuel mixture in the air/fuel intake tube 30, the manifold 32, and the burner tubes 34.

In the embodiment of the lantern shown in the drawing, the ends of the burner tubes 34 include a specific structure, i.e., the mantle mounts 36, onto which mantles 22 are mounted. Although the mantle mounts 36 are often used herein when describing the invention, the mantles 22 may be mounted or installed on any size or shape of structure. To this end, as used herein, “mantle base” is any structure on which a mantle or mantles (e.g., the mantle 22) are mounted. In addition, the mantle clip 24 and mantles 22 of the present invention may be configured as needed so as to fit onto, into, or otherwise attach to a specific mantle base.

The mantle clip 24 is preferably configurable between a first, opened position and a second, closed position. When configured in the closed position, the mantle clip 24 fits onto a mantle base and the mantle clip holds the mantle 22 and mantle base into position on the mantle base, without requiring additional support for the attachment of these two elements to the mantle base. In the opened position, the mantle clip 24 and mantle 22 may be more easily released from or placed on the mantle base. Moving between the opened and closed positions causes the mantle clip to move between a released state (the opened position) in which the mantle 22 and the mantle clip 24 may be easily removed from the mantle base, and the closed position. Specific structures of mantle clips and configuration of the mantle clips between the opened and closed positions are described below.

In general, as described further below, the holder 20 of the present invention includes a gripping portion and one or more abutment portions. The gripping portion is designed so that a user may hold, grasp, or otherwise manipulate the holder 20 so that a mantle clip 24 and mantle 22 attached to the holder 20 may be moved between the opened position and the closed position. The mantle clip 24 and mantle 22 may be closed onto a mantle base (e.g., one of the mantle mounts 36). The abutment portion or portions are designed to support the mantle clip 24, and may also be configured to bias the mantle clip into the opened position.

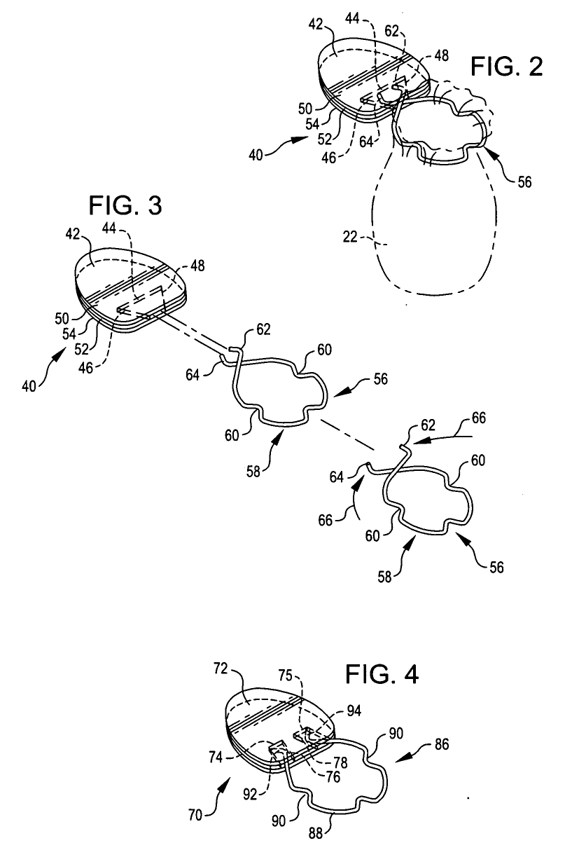

In any event, an embodiment of a holder 40 is shown in FIGS. 2 and 3. The holder 40 includes a gripping portion 42, which is a tear-shaped tab. A slot 44 is formed in the face of the holder 40, and includes a first abutment 46 on the left side of the slot and a second abutment 48 on the right side of the slot. Each of these abutments 46, 48 forms a wall of the inside of the slot 44, and tapers outward so that the slot 44 is wider away from its opening than at its opening.

The holder 40 may be formed out of plastic, paperboard, metal, wood, or any suitable material, but preferably is formed of a biodegradable material. In one embodiment, the holder 40 is formed of first, second, and third layers 50, 52, 54 of paperboard, with a notch cut into the central layer 52 so as to form the slot 44. These three layers 50, 52, 54 may be glued together, for example with a biodegradable glue.

The holder 40 is configured to work with the mantle clip 56 shown in FIGS. 2 and 3. The mantle clip 56 includes a central bight portion 58, having V-shaped projections 60 extending inward, such as is disclosed in the '231 patent. The function and utility of the V-shaped projections 60 are described in detail in the '231 patent, and will not be repeated herein. However, in summary, in accordance with one aspect of the '231 patent, projections, such as the V-shaped projections 60, space the bulk of a mantle away from a mantle mount so that the mantle does not fully contact the burner tubes or mantle base. While the V-shaped projections work well to space the mantle from the mantle mount, the present invention may be practiced without such projections.

The mantle clip 56 may be formed of any suitable material, and in accordance with one aspect of the present invention, may be formed of a flexible, resilient metal, such as 302/304 one-half hardness stainless steel wire having a diameter of 0.032 inches. This material may be used, for example, for the mantle clip 56 shown in FIGS. 2 and 3, wherein the resilience of the mantle clip 56 is used to bias the mantle clip into contact with a mantle mount. The mantle clip 56 may be, for example, a unitary piece of wire bent to the shape shown in FIGS. 2 and 3. Other suitable materials may be used and may be selected in accordance with the manner in which the particular mantle clip attaches to a mantle mount.

The mantle clip 56 shown in FIGS. 2 and 3 includes end portions 62, 64 having bent angles at distal ends thereof. The mantle clip 56 is shown in the bottom right-hand portion of FIG. 3 in an unbiased, relaxed position.

A mantle (e.g., the mantle 22) is attached to the mantle clip 56 in a conventional fashion. In general, as is known, a mantle is a bag or other cloth made of a catalytic material. Mantles typically include an open end for fitting onto a mantle. The mantle clip 24 or 56 is fitted around the opening on the mantle, and may be attached in any suitable manner. For example, the mantle 22 may be attached to the mantle clip 56 by sewing, threading a pleater head onto the mantle clip 56, or in another suitable manner. Each of these types of attaching of a mantle to a mantle clip are known, and some methods for attaching a mantle to a mantle clip are described in the '231 patent.

In any event, after a mantle (e.g., the mantle 22) is installed on the mantle clip 56, then the end portions 62, 64 are pushed in as shown by the arrows 66. The two end portions 62, 64 are pushed inward, against the resistance of the mantle clip 56, until they are in the configuration shown in the middle of FIG. 3. The two end portions 62, 64, are held in this position and are inserted into the slot 44. The mantle clip 56 and/or the end portions 62, 64 may then be released, and the end portions are held in the biased position by the contact of the end portions 62, 64 with the abutments 46, 48.

The combined holder 40, mantle clip 56, and mantle 22 shown in FIG. 2 would be sold as shown to consumers. Preferably, top edges of the mantle 22 may be ironed outward so as to provide an opening for installation of the mantle 22 and mantle clip 56 onto a mantle mount.

To install the mantle clip 56 and mantle 22 onto a mantle mount, a user grasps the gripping portion 42 of the holder 40 so that the mantle clip 56 and the mantle 22 extend outward. The user then places the central bight portion 58 of the mantle clip 56 around a mantle mount 36. Once a rear portion of the central bight portion 58 is hooked around the mantle mount 36, the user may remove the holder 40 from the mantle clip 56. In the example shown in the drawings, the user may pull rearward on the holder 40. Doing so causes the end portions 62, 64 of the mantle clip 56 to roll over the first and second abutments 46, 48, until the end portions are outside of the slot 44. At this position, the end portions 62, 64 spring back due to the bias of the mantle clip 56 into the original position shown in the bottom right-hand corner of FIG. 3. At this position, the inner diameter of the central bight portion 58 fits the mantle mount 36. Thus, the mantle clip 56 and the mantle 22 are installed. The holder 40 may then be properly disposed, such as by throwing the holder 40 into a suitable waste container, or by burning if made of a suitable material.

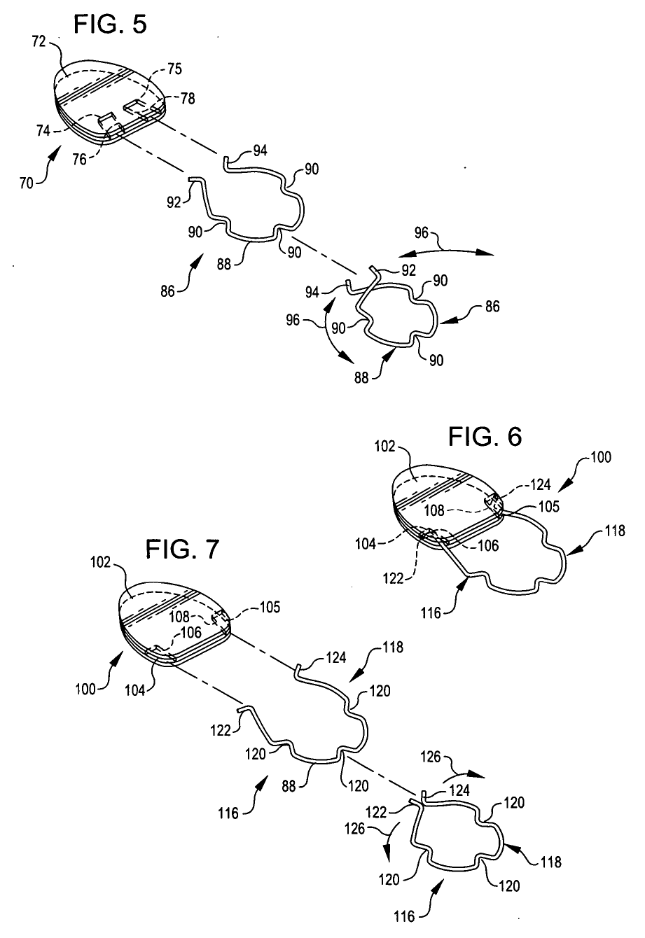

A second embodiment of a holder 70 is shown in FIGS. 4 and 5. The holder 70 includes a gripping portion 72 similar to the gripping portion 42 of the holder 40. However, instead of a single slot 44, the holder 70 includes two slots 74, 75. Abutments 76, 78 are formed on the inner walls of the two slots 74, 75, respectively.

A mantle clip 86 for use with the holder 70 is also shown in FIGS. 4 and 5. Like the mantle clip 56, the mantle clip 86 includes a central bight portion 88 having V-shaped projections 90. The end portions 92, 94, however, are shaped differently, and are shorter, with the ends being bent, but not quite at as drastic an angle as the ends of the end portions 62, 64 of the mantle clip 56.

The mantle clip 86 is installed on the holder 70 in much the same manner as the mantle clip 56 was installed on the holder 40. However, the end portions 92, 94 are bent outward instead of inward to bias the bight 90 into an opened position. That is, a mantle 22 is installed on the mantle clip 86, and the two end portions 92, 94 are bent outward in accordance with the arrows 96. The end portions 92, 94 are then inserted into the two slots 74, 75, respectively, and the mantle clip 86 is released so that the ends of the end portions 92, 94 are pressed against the abutments 76, 78. The mantle clip 86 is shown installed in the holder 70 in FIG. 4.

A mantle 22 is not shown in FIG. 4 or 5 so that details of the holder 72 and mantle clip 86 may be seen, but a mantle 22 may be installed on the mantle clip 86 similar to the installation of the mantle 22 on the mantle clip 56. The combined mantle 22, mantle clip 86, and holder 70 form a mantle assembly (e.g., the mantle assembly 26) that may be sold as a unit to a consumer.

The mantle clip 86 and mantle 22 are installed on a mantle mount 36 in much the same manner as the mantle clip 56. The central bight portion 88 is placed around the mantle mount 36 and the holder 70 is pulled rearward until the two ends of the end portions 92, 94 release from the slots 74, 75. The ends then return to the shape shown in the bottom right-hand corner of FIG. 5, and the spring biasing of the mantle clip 86 holds the mantle clip and mantle 22 in position on the mantle mount 36.

The configuration of the holder 70 shown in FIGS. 4 and 5 has an advantage over the configuration of the holder 40 shown in FIGS. 2 and 3 in that the two separate slots 74, 75 may be used to more securely hold the ends of the end portions 92, 94 of the mantle clip 86. This advantage may be useful, for advantage, when a mantle clip is used that does not have much spring resilience, but instead relies upon a latching between the end portions 92, 94 to hold the mantle clip 86 in place. In such an embodiment, the holder 70 may be twisted so as to criss-cross and positively latch the two end portions together. In this manner, the mantle clip 86 may be locked onto a mantle mount 36, without the use of a biasing spring force within the mantle clip 86.

Another embodiment of a holder 100 is shown in FIGS. 6 and 7. The holder 100 is shaped similar to the holders 40 and 70, with a similarly shaped gripping portion 102. However, for the holder 100, slots 104, 105 are formed on outer front edges of the holder 100. Abutments 106, 108 are formed on the inner walls of these slots 104, 105, respectively.

A mantle clip 116 for use with the holder 100 is shown in FIGS. 6 and 7. The mantle clip 116 includes a central bight portion 118, similar to the central bight portions 88 and 58, and V-shaped projections 120. However, unlike the mantle clips 56 and 86, the end portions 122, 124 of the mantle clip 116 are aligned approximately in the same position when the mantle clip 116 is in a relaxed position, shown in the bottom right-hand corner of FIG. 7.

To install the mantle clip 116, the end portions 122, 124 are pulled outward along the arrows 126 to the position shown in the center of FIG. 7. The mantle clip 116, with a mantle 22 mounted thereon, is then installed on the holder 100 by inserting the ends of the end portions 122, 124 into the slots 104, 105. The mantle clip 116 may then be released, and the ends of the end portions 122, 124 abut the abutments 106, 108 inside the slots 104, 105. In this manner, the mantle clip 116 is held in the open position shown in FIG. 6. The holder 100, mantle clip 116, and a mantle 22 installed thereon may be sold to a consumer.

A user wishing to install the mantle clip 116 and a mantle 22 would place the central bight portion 118 over a mantle mount 36 and pull rearwardly on the holder 100 until the ends of the end portions 122, 124 are released from engagement with the abutments 106, 108 and slide out of the slots 104, 105. The ends of the end portions 122, 124 then return to the position shown in the bottom right-hand corner of FIG. 7, and are positioned to lock against the outer diameter of the mantle mount 36.

Thus, as can be seen, the mantle clip 24 of the present invention may be biased inward or outward by the holder, or may be twisted by the holder so as to lock the holder 20 in place. Other arrangements may be provided, such as where the holder 20 may be bent downward to lock a mantle clip 24 into place, a mantle clip includes only one leg or attaches to a holder in a different manner, or other suitable arrangements may be provided.

Although the holders 40, 70, and 100 are shown shaped as small tabs, the holder 20 may take several different forms. As nonlimiting examples, the holder 20 may be elongate so that a mantle may be installed without a user sticking his or her hand very near the lantern 10, or may be bent so as to allow a user to insert the mantle clip 24 and mantle 22 into a globe and install the mantle onto a mantle mount 36 without removing the globe. In addition, the structure of the holder 20 may take several different forms, including a shape similar to a straw in which the two end portions of a mantle clip are inserted, or other suitable forms that allow a user to install a mantle clip 24 and mantle 22 onto a mantle mount 36.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

1-25. (canceled)

26. A method of installing a mantle in a lantern, comprising:
gripping a holder attached to a mantle clip, the mantle clip having the mantle attached thereto and defining a bight and two ends, the two ends being biased relative to one another toward a first, biased position, and the holder having two fixed abutments against which the legs are held and for extending the bight against the bias of the two ends and away from the first, biased position;
extending a bight of the mantle clip around a mantle base of the lantern so that the mantle clip is aligned with a mantle base on the lantern; and
pulling outward on the holder so as to release the two ends of the mantle clip from the holder so that the mantle clip and mantle are attached to the mantle base.

27. The method of claim 26, wherein releasing comprises removing the ends of the mantle clip from contact with abutment portions on the holder by the legs sliding over the abutments and then releasing toward the first, biased position.

28. A mantle assembly, comprising:
a mantle;
a mantle clip attached to the mantle and configurable between a first position in which the mantle clip may attach to a mantle base on a lantern, and a second position in which the mantle clip may be manipulated relative to the mantle base, the mantle clip defining a bight and two ends, the two ends being biased relative to one another toward a first, biased position; and
a holder having two fixed abutments against which the legs are held and for extending the bight against the bias of the two ends, the holder being configured so that pulling outward on the holder when the mantle clip is attached to a mantle base releases the two ends of the mantle clip from the holder so that the mantle clip and mantle are attached to the mantle base.

29. The mantle assembly of claim 28, wherein the fixed abutments are configured so that when the mantle clip is released from the holder, the legs slide over the abutments and then release toward the biased position.

30. The mantle assembly of claim 28, wherein the mantle clip comprises a unitary wire having the two ends.

31. The mantle assembly of claim 30, wherein the two ends are biased toward one another, and wherein the abutment surfaces are positioned to hold the two ends apart.

32. The mantle assembly of claim 30, wherein the two ends are biased apart, and wherein the abutment surfaces are positioned to bold the two ends toward one another.

33. The mantle assembly of claim 30, wherein the two fixed abutment surfaces are positioned on the inside of a single slot on the holder.

34. The mantle assembly of claim 30, wherein the two fixed abutment surfaces are positioned on the inside of two separate slots on the holder.

35. The mantle assembly of claim 28, wherein each of the fixed abutment surfaces comprise a slot for receiving one of the two ends.

36. The mantle assembly of claim 28, wherein the two fixed abutment surfaces are positioned on the inside of a single slot on the holder.

37. The mantle assembly of claim 28, wherein the holder comprises paperboard.

38. A mantle assembly, comprising:
a mantle;
a mantle clip attached to the mantle and comprising a unitary wire having a pair of ends and a bight section, the bight section being configurable between a first, narrower position in which the mantle clip may fit against and around a mantle base on a lantern, and a second, wider position in which the mantle clip may fit loosely around the mantle base, the mantle clip being biased toward the first position; and
a holder having two fixed abutments against which the legs are held and for extending the bight into the second position, the holder being configured so that pulling outward on the holder when the mantle clip is attached to a mantle base releases the two ends of the mantle clip from the holder to release the mantle clip from the second position so that the mantle clip may move according to the bias toward the first position.

39. The mantle assembly of claim 38, wherein the mantle clip comprises a unitary wire having the two ends.

40. The mantle assembly of claim 38, wherein the two ends are biased toward one another, and wherein the abutment surfaces are positioned to hold the two ends apart.

41. The mantle assembly of claim 38, wherein the two ends are biased apart, and wherein the abutment surfaces are positioned to bold the two ends toward one another.

42. The mantle assembly of claim 38, wherein the two fixed abutment surfaces are positioned on the inside of a single slot on the holder.

43. The mantle assembly of claim 38, wherein the two fixed abutment surfaces are positioned on the inside of two separate slots on the holder.

44. The mantle assembly of claim 38, wherein the holder comprises paperboard.

45. The mantle assembly of claim 38, wherein the fixed abutments are configured so that when the mantle clip is released from the holder, the legs slide over the abutments and then release toward the first position.
